(19) United States
(12) Patent Application Publication
(10) Pub. No.: US 2008/0202381 A1
(43) Pub. Date: Aug. 28, 2008

(54) Adhesive Composition

(76) Inventors: Freddy Johannes Martina Andriessen, Hulst (NL); Elvira Wolf, Krefeld (DE); Jure Anic, Krefeld (DE)

Correspondence Address: PERKINS COIE LLP;PATENT-SEA, P.O. BOX 1247, SEATTLE, WA, 98111-1247, US

(21) Appl. No.: 11/917,120

(22) PCT Filed: Jun. 8, 2006
(86) PCT No.: PCT/EP06/05469

§ 371 Date: Dec. 10, 2007

(30) Foreign Application Priority Data
Jun. 8, 2005 (EP) 05253510.1

(51) Int. Cl. C09J 103/02

(52) U.S. Cl. 106/206.1

(57) ABSTRACT

There is provided an adhesive composition comprising a carrier starch and a secondary starch characterised in that the carrier starch: —comprises, on a dry weight basis, less than 50% pre-gelatinised starch; and has a higher alkali sensitivity than the secondary starch. There is further provided a process for preparing such and adhesive composition.

### FIELD OF THE INVENTION

The present invention relates to adhesive compositions, in particular to so-called one-bag-mix (OBM) adhesive compositions, and to a process for preparing them.

### BACKGROUND OF THE INVENTION

Adhesives for use in the paper processing and corrugating industries are typically classified as either Stein Hall or Minocar type adhesives.

Stein Hall type adhesives are prepared by dispersing about 10-25% of the total starch in a primary liquid (water). This portion of the total starch is called “primary starch”. The mix is heated and a defined amount of alkali is then added. This leads to full gelatinisation of the primary starch, resulting in a high viscosity starch paste (known as “carrier”). Secondary water is then incorporated to reduce the temperature and alkali concentration of the carrier. Finally, a secondary starch (accounting for about 75-90% of the total starch) is added, together with other compounds such as borax if required.

By contrast, Minocar type adhesives are prepared with much higher levels of primary starch (approximately 40-60% of the total starch). Alkali is added gradually to the carrier until a defined viscosity level is achieved. Once this viscosity level is reached, the swelling of the carrier is stopped by very quickly adding the remaining (secondary) liquid and starch (plus other compounds, if required).

Both these types of adhesives suffer from the drawback that they have to be prepared by the user, thereby requiring not only additional time resources and equipment but also a certain level of technical expertise. A third type of adhesive has therefore been developed. These are known as “one-bag-mix” (OBM) adhesives. They provide a single dry ingredient pre-mix that can be prepared in a straightforward one-step process, simply by adding to water.

OBM adhesives have been available on the market for more than forty years. They typically comprise, together with caustic producing chemicals and a boron compound, both a carrier and a secondary starch. Whereas the secondary starch is usually a native starch with a relatively high gelatinisation temperature (e.g. about 70° C. in the case of corn starch), OBM carrier starches are traditionally selected from pre-gelatinised (or “roll-dried”) starches. Unfortunately, the use of such starches is very costly.

An alternative to the products that exist in the art is therefore required. The present invention provides such an alternative.

### BRIEF DESCRIPTION OF THE FIGURES

FIG. 1: Alkali sensitivity of different starches at 25° C.

FIG. 2: Alkali sensitivity of different starches at varying temperatures

FIG. 3: Alkali Brabender value determination of corn and wheat starch

FIGS. 4+5: Characteristics of adhesives prepared according to different processes

FIG. 6: Apparatus for gel-point determination

### STATEMENTS OF THE INVENTION

According to a first aspect of the present invention, there is provided an adhesive composition comprising a carrier starch, a secondary starch and an alkali characterised in that the carrier starch:
comprises, on a dry weight basis, less than 50% pre-gelatinised starch; and
has a higher alkali sensitivity than the secondary starch.

Preferably, the difference in alkali sensitivity between the carrier starch and the secondary starch will be at least 0.05% NaOH, preferably 0.1% NaOH, more preferably at least 0.15% NaOH.

According to a further aspect of the present invention, there is provided a process for preparing an adhesive comprising the steps of adding the above composition to water and mixing, characterised in that sufficient alkali is added to gelatinise the carrier starch but not the secondary starch during mixing.

According to a yet further aspect of the present invention, there is provided a process for preparing an adhesive comprising the steps of adding a carrier starch, a secondary starch and at least an alkali to water and mixing, characterised in that the carrier starch:
comprises, on a dry weight basis, less than 50% pre-gelatinised starch; and
has a higher alkali sensitivity than the secondary starch;
   and in that sufficient alkali is added to gelatinise the carrier starch but not the secondary starch during mixing.

Preferably, before addition of the starches and alkali, the water is pre-heated to 20-60° C., preferably 30-50° C., more preferably 35-45° C., more preferably 40-45° C.

There is further provided an adhesive prepared according to the above process and board materials prepared using such an adhesive.

### DETAILED DESCRIPTION

The present invention provides an adhesive composition comprising a carrier starch, a secondary starch and an alkali characterised in that the carrier starch:
comprises, on a dry weight basis, less than 50% pre-gelatinised starch; and
has a higher alkali sensitivity than the secondary starch.

As used in the art, the term “adhesive composition” can refer to both dry and aqueous adhesive compositions. Dry compositions (e.g. of the one-bag-mix type) comprise some or all of the ingredients required to produce an aqueous composition by addition of water and/or other liquids. The ingredients of an aqueous compositions may be only partially diluted or they may be fully diluted and ready for use.

For the purpose of clarity alone, and unless specifically stated otherwise, dry compositions shall be referred to herein as “adhesive compositions” and aqueous compositions shall be referred to simply as “adhesives”. Preferably, the adhesive composition of the present invention is a one-bag-mix type adhesive composition.

The adhesive composition of the present invention comprises, as a minimum, a carrier starch, a secondary starch and an alkali. The principal role of the carrier starch, in the finished adhesive, is to create a certain level of viscosity thereby allowing for a stable dispersion (or “suspension”) of the raw, ungelatinised secondary starch. This is traditionally achieved, for OBM-type adhesives, by using a pre-gelatinised (and therefore cold-water-soluble) carrier starch.

The carrier starch of the present invention, however, comprises less than 50% pre-gelatinised starch. As used herein, the expression “dry weight basis” refers to the content of an ingredient (in this case pre-gelatinised starch) expressed as a percentage of the total dry weight of the composition (in this case of the carrier starch), calculated from the commercial basis dry weight of that ingredient. Preferably, the carrier starch will comprise less than 40%, more preferably less than 30%, more preferably less than 20%, more preferably less than 10%, more preferably less than 5% pre-gelatinised starch. According to a most preferred embodiment, the carrier starch will comprise substantially no pre-gelatinised starch. Instead, the carrier starch of the present invention is characterised by its alkali sensitivity, specifically by an alkali sensitivity which is significantly higher than that of the secondary starch.

It is indeed believed that, at a certain concentration and when mixed with water, the alkali will only gelatinise the more sensitive carrier starch. The secondary starch will not be attacked. Instead, the secondary starch will gelatinise during or after application of the adhesive, under the action of heat and/or pressure (e.g. on a corrugating machine) to produce a starch paste with a drastically increased viscosity. It is this increase in viscosity which leads to the formation of an adhesive bond.

In theory, provided the above sensitivity criteria are met and with the proviso that the carrier starch comprises less than 50% pre-gelatinised starch, both the carrier and secondary starches may be selected from any native or modified starches or starch derivatives (including, for instance, esterified, etherified or thinned starches). According to one preferred embodiment, the carrier starch will be a carboxy-methylated starch.

The carrier starch and the secondary starch will preferably be chosen such that the difference in alkali sensitivity between the two is at least 0.05% NaOH, preferably 0.1% NaOH, more preferably at least 0.15% NaOH (wherein alkali sensitivity is measured according to Method 1 as set out below). Thus, for example, if corn starch is selected as the secondary starch, the carrier starch may be any one or more of wheat starch, potato starch, tapioca starch and barley starch. It should be noted, however, that corn starches with significantly different alkali sensitivities do exist. It would therefore be possible for both the carrier and secondary starches to be derived from corn (or from any other source which produces starches with significantly different alkali sensitivities, e.g. tapioca or potato). Nonetheless, if corn starch is selected as the secondary starch, the carrier starch will preferably be wheat starch.

By way of illustration only, the following table (simplified from Kofler, “Starch: Chemistry and Technology”, 2^{nd} edition—1984, page 668, Table III) gives the standard gelatinisation temperatures of a number of commonly available starches.

| Starch type | Gelatinization temperature (° C.) |
|---|---|
| Corn | 62-72 |
| Sorghum | 68-78 |
| Wheat | 58-64 |
| Tapioca - Brasilian | 49-64.5 |
| Tapioca - Dominican | 58.5-70 |
| Tapioca - Siamese | 62-73 |
| Potato | 50-68 |
| Waxy maize | 63-72 |
| Waxy sorghum | 67.5-74 |
| Barley | 51.5-59.5 |
| Rye | 57-70 |
| Pea (green garden) | 57-70 |
| Rice | 68-78 |
| High amylase corn | 67 - * (complete gelatinisation not effected in |
| | boiling water) |

The same differences, shifted to lower values, can be observed when the starches are suspended in water under alkali conditions. For the purpose of the present invention, however, Method 1 (as defined below) will be used to determine differences in alkali sensitivity.

Examples of some preferred carrier/secondary starch combinations include:

| Carrier Starch | Secondary Starch |
|---|---|
| Native wheat starch | Native corn starch |
| Native potato starch | Native corn starch |
| Native potato starch | Native wheat starch |
| CMS* potato starch | Native wheat starch |
| CMS* potato starch | Native potato starch |
| Native potato + native wheat starch | Native corn starch |
| CMS* potato + native wheat starch | Native corn starch |

*CMS = carboxy-methylated starch

The exact composition of the final adhesive will of course depend on its desired characteristics (such as total dry substance), intended end-use and the inclusion, for instance, of synthetic binders, hydrocolloids, thickeners and other chemical additives. Nonetheless, a preferred composition will comprise, on a dry weight basis, 0.5-60%, preferably 5-40%, more preferably 5-25%, more preferably 5-15% carrier starch and 40-99.5%, preferably 75-95%, more preferably 80-90% secondary starch.

The adhesive composition will also comprise an alkali. The alkali may be selected from one or more of sodium carbonate, calcium hydroxide, sodium hydroxide and other suitable alkali compounds known to those skilled in the art. According to a preferred embodiment, the adhesive composition will comprise sodium carbonate and calcium hydroxide which, when added to water, react to form caustic soda (according to the formula Na₂CO₃+Ca(OH)₂=2 NaOH+CaCO₃). Preferably, the composition will comprise alkali in an amount, on a dry weight basis, of 1-8%, more preferably in an amount of 3-6%.

The composition may also comprise a bon compound. Boron compounds are used as rheology regulators and adhesion boosters and may be selected from one or more of borax decahydrate, boric acid, borate and other boron compounds known to the skilled person. According to a preferred embodiment of the present invention, the boron compound will be borax decahydrate. Preferably, the composition will comprise boron compounds in an amount, on a dry weight basis, of 0.1-3.5%, more preferably of 0.5-2.5%, more preferably of 1.2-1.7%.

Thus, according to one preferred embodiment, the adhesive composition of the present invention will comprise a carrier starch, a secondary starch, a alkali and a boron compound, characterised in that the carrier starch comprises less than 50% pre-gelatinised starch and has a higher alkali sensitivity than the secondary starch. Upon addition of this composition to batch water, the alkali will attack the carrier starch causing it to swell. By contrast, at this stage, the lower sensitivity secondary starch will not swell.

Accordingly, the present invention further provides a process for preparing an adhesive comprising the steps of adding the basic composition defined above to water and mixing, characterised in that sufficient alkali is added to gelatinise the carrier starch but not the secondary starch during mixing.

The invention further provides a process for preparing an adhesive comprising the steps of adding a carrier starch, a secondary starch and at least an alkali to water and mixing, characterised in that the carrier starch:
comprises, on a dry weight basis, less than 50% pre-gelatinised starch; and
has a higher alkali sensitivity than the secondary starch;
   and in that sufficient alkali is added to gelatinise the carrier starch but not the secondary starch during mixing.

Preferably, the ratio of water to other ingredients will be determined such that the total dry substance of the final adhesive is 15-40% by weight, preferably 20-35% by weight, more preferably, 20-30% by weight.

The gelatinisation of any given starch, in the presence of an alkali, is dependant on a number of factors, and in particular on water temperature and alkali concentration. These factors will have to be determined, amongst others, in accordance with the type of carrier starch and secondary starch being used in the process of the invention and with the gelatinisation temperature of the final adhesive in mind. Thus, for example, the higher the required gel-point of the adhesive, the less alkali will be needed and the higher the temperature of the batch water should be.

Preferably, the water will be pre-heated to 20-60° C., more preferably to 30-50° C., more preferably to 35-45° C., most preferably to 40-45° C.; the quantity and type of alkali to be used will be readily determined by the skilled person but will preferably be between 1 and 8%, more preferably between 3 and 6%, on a dry weight basis. Examples of alkali compounds that may be used are defined above.

In addition to the above factors, the carrier starch should be given enough time to swell before the adhesive is used. The water, carrier starch, secondary starch, alkali and any other optional ingredients should therefore preferably be mixed for at least 10 min, more preferably for 10 min to 1 hour, more preferably for 20-40 min, more preferably for approximately 30 minutes. According to one embodiment, the carrier and secondary starches may be mixed with the water before the alkali, boron compounds and/or other optional ingredients are added.

The liquid composition thus prepared will be ready for use. Thus, the present invention further provides an adhesive prepared according to the above process. Such adhesives may be used in any number of applications including, in particular, in corrugating and/or paper processing applications. The invention therefore also provides products prepared using the above adhesive. These products (generally referred to as “board materials”) include, for example, corrugated board and multi-layer paper materials.

### ADVANTAGES OF THE INVENTION

A number of advantages are associated with the adhesive composition of the present invention. In particular, they are simple to prepare (compared to typical Stein Hall or Minocar type adhesives), requiring less time, equipment and technical expertise. They can be delivered as a one-bag-mix but do not rely on the use of a chemically modified pre-gelatinised carrier starch. They are therefore cheaper, safer and more environmentally-friendly to make and use. In fact, the carrier starch of the present invention may be a native starch which is, in effect, generated in situ during the mixing process. They have good adhesive functionality and desirable rheological properties (such as a relatively short structure, stable viscosity, good runability and a thixotropic behaviour). In this respect, they are comparable to traditional Minocar type adhesives. Industrial scale corrugating trials have also shown that use of the present adhesive leads to better board quality (e.g. flatter plates, less curling, etc.), decreased glue consumption and increased production speed.

### Method 1: Test Method for Alkali Sensitivity of Starches

1. Prepare a first batch of 500 g of starch slurry at 10% solids (on a dry weight basis) by adding 50 g starch to a 600 ml glass beaker containing 450 g distilled water. The solution should be continuously stirred with a magnetic stick and kept at 25° C. (+/−1° C.);
2. Determine the Stein Hall (SH) viscosity of the slurry (this should be close to that of water, i.e. 15-16 sec.);
3. Prepare a solution of NaOH at 20% solids (on a dry weight basis);
4. Calculate the amount of NaOH solution required in order to dose exactly 0.375% NaOH (ds.) w/w to the 500 g of slurry;
5. Add the calculated amount of NaOH to the slurry slowly but in one go. Continue stirring for exactly 10 minutes;
6. Determine the SH viscosity of the alkali slurry. Discard this first batch;
7. Repeat steps 1 to 6 with a second batch, but increase the NaOH concentration at step 4 to 0.4% (ds.) w/w;
8. Continue the procedure (i.e. increasing NaOH concentration) until a very strong viscosity is obtained;
9. Prepare a graph of viscosity vs. alkali concentration and determine the starting point of starch gelatinisation.

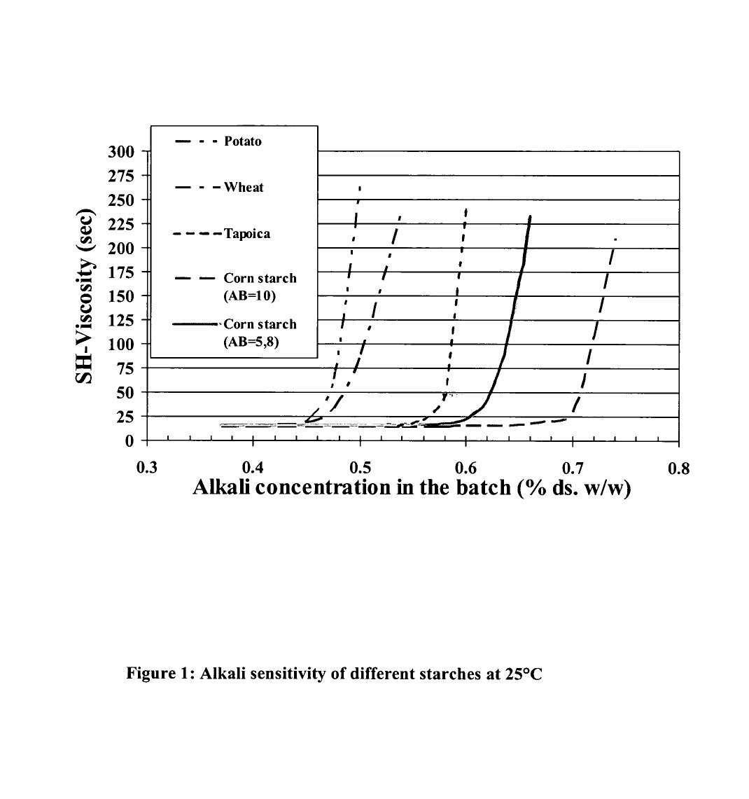

A number of commonly used starches were analysed in this way. The results are shown in the graph of FIG. 1. As can be seen from this graph, potato starch and wheat starch need much less alkali (0.45% w/w) to start gelatinisation than corn starch (0.58% w/w). In other words, both potato and wheat starch have a higher alkali sensitivity than corn starch.

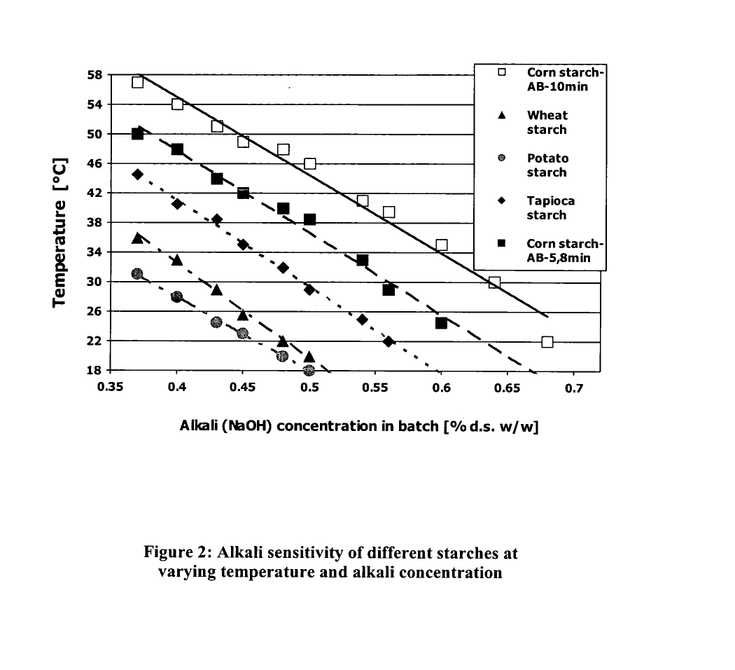

Since temperature also affects gelatinisation properties, a further analysis can be performed as illustrated in the graph of FIG. 2. This graph shows the behaviour of different starches in relation to both alkali concentration and temperature. It allows a precise estimation, for each starch type and at a certain alkali concentration, of the gelatinisation temperature (i.e. of the temperature at which swelling begins). The graph was prepared by repeating the method described above (for FIG. 1) at different temperatures and by plotting, for each alkali concentration, the exact temperature at which an increase in viscosity was first observed. A difference in alkali sensitivity between two starch types can then be established by comparing, at any given temperature, the different concentration of alkali required to initiate gelatinisation.

Thus, it can be seen that, for example at 38° C., wheat starch requires 0.355% ds w/w NaOH to begin gelatinisation whereas a corn starch (AB 5.8 min) requires 0.49% ds w/w NaOH: wheat starch has a higher alkali sensitivity than corn starch. The difference in alkali sensitivity between these two starch types is approximately 0.135% ds w/w NaOH.

### Method 2: Alkali Brabender Method for Determining Alkali Sensitivity

An alternative definition for the alkali sensitivity of starches used in the corrugating industry is the Alkali Brabender (AB) value. The AB value of any particular starch is the time taken by that starch to reach 100 Brabender Units (BU) under strictly defined conditions:

1. Start-up and calibrate a Viscograph E viscometer (Brabender) according to the supplier's instruction manual. The following parameters should be set: measurement torque (250 cmg), recorder speed (1 cm/min), revolution speed (75 rpm), starting temperature (17° C.), nominal temperature (50° C.), heating rate (1.5° C./min), chart speed (1 cm/min). A 350 cmg cartridge should be used.
2. Place a 600 ml squat glass beaker on the laboratory balance and zero the balance.
3. Weigh out a starch sample to the nearest 0.01 g, using the following formula:

| Corn | Wheat | Potato |
|---|---|---|
| m = (25 × 88)/d.s. | m = (25 × 88)/d.s. | m = (25 × 82)/d.s. |

where m is the weight of the starch sample, expressed in g and d.s. is the dry substance of the starch, expressed in percent w:w.
4. Add precisely (445-m) g of refrigerated demineralised water (between 4 and 10° C.) to the beaker. Place the beaker on the magnetic stirrer, introduce a follower and slurry the starch.
5. While the starch is being stirred, fill a 100 ml burette with refrigerated caustic soda (1.0 M sodium hydroxide—Merck Nr 109137).
6. When a homogeneous slurry is achieved, with a temperature between 14° C. and 16° C., add (in about 90 seconds) 50 ml of refrigerated caustic soda from the burette.
7. Pour the slurry into the Brabender viscometer cup (which has been cooled to 4-15° C. in the fridge or a water bath), and insert the measuring head and the sensor.
8. Start the Brabender program in accordance with the instruction manual. At this stage, the temperature of the slurry should be lower than 17° C.
9. When a temperature of 20° C. is reached, start the chronometer and record the time (in minutes) taken to reach 100 BU.

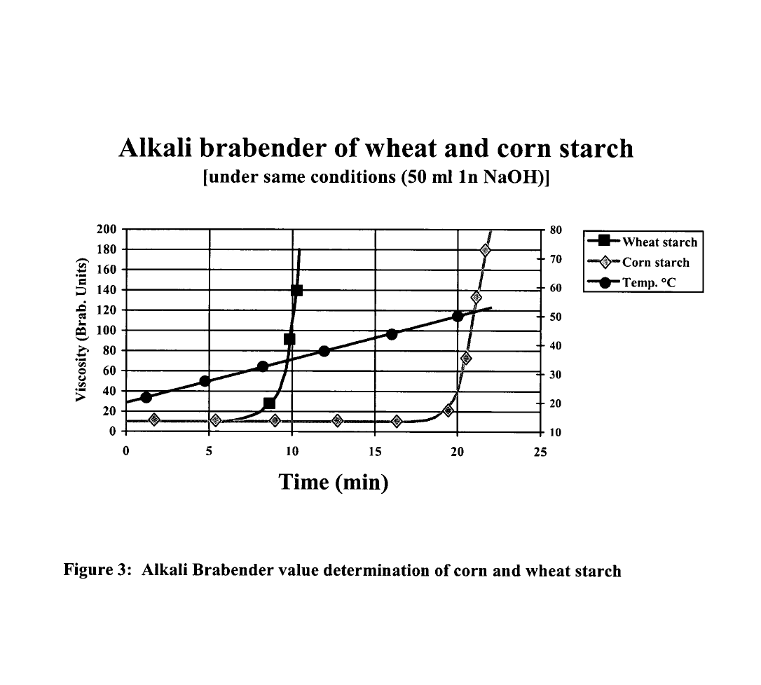

According to this method, the difference in alkali sensitivity between corn and wheat starch can be determined, as illustrated in the graph of FIG. 3. From this graph, it is apparent that the AB value of corn starch (20.8) is more than double that of wheat starch (9.9) and that corn starch is thus much less sensitive to alkali than wheat starch.

For the purpose of the present invention, the difference in caustic sensitivity between a carrier starch and a secondary starch can be expressed as follows:

(AB value of secondary starch)−(AB value of carrier starch)

The difference between these two values should be at least 5 min, preferably at least 8 min.

### Method 3: Gelatinisation Temperature of Adhesives

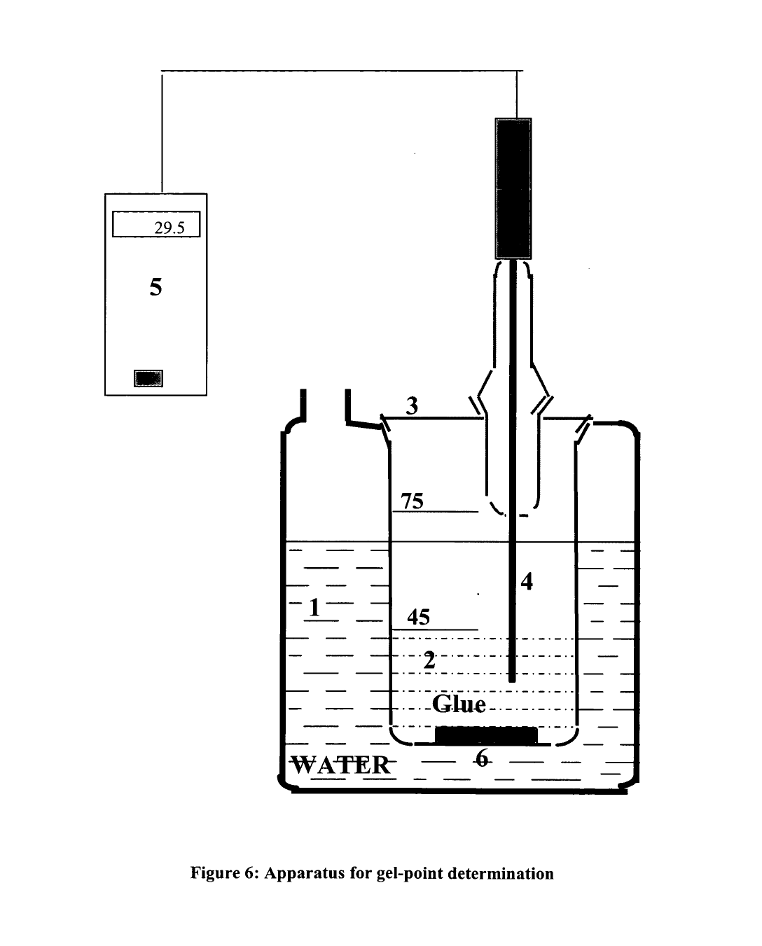

1. Using the apparatus shown in FIG. 6, fill outer glass chamber (1), until the upper blue marking line (75) of the internal glass chamber (2), with deionised water.
2. Place a magnetic stirrer (6) into the internal glass chamber (2) then fill (until the lower blue marking (45)) with the corrugating adhesive to be tested.
3. Assemble the apparatus as shown in FIG. 5—where (3) represents a glass cover; (4) represents a 145 mm thermoelectric tracer, retained in a fixed position in a glass tube such that its tip is about 25-30 mm from the bottom of the internal glass pot; and (5) represents an indicator for temperature measurement—and place on a heating plate set at exactly 250° C.
4. Switch on indicator (5). During the first few minutes, the temperature will decrease by about 2-3° C. because of the cold water in the outer glass chamber. After few minutes, the temperature will start to rise continuously up to the gelatinisation temperature (or “gel point”). Once the gel point is reached, the temperature increase will stop and begin to slightly decrease by about 0.1 to 0.5° C. (at the same time, the magnetic stirrer will stop rotating due to a sudden increase in viscosity). The highest temperature reached before this decrease corresponds to the gel point of the adhesive.

### EXAMPLES

A number of trials were carried out to compare the characteristics of a standard OBM adhesive (trial 1), a SH-type adhesive (trial 2) and a number of adhesives according to the present invention (trials 3-12). The details of each of these trials is shown in Tables 1 and 2.

All the adhesives were prepared with 1050 g batch water and stirred at 930 l/min for an initial 30 min. The SH-type adhesive of trial 2 was prepared with 404.4 g primary water and 629.17 g secondary water. The temperature of the batch water was set at 40° C. for all trials except Trial 1 where is was set at 25-30° C.

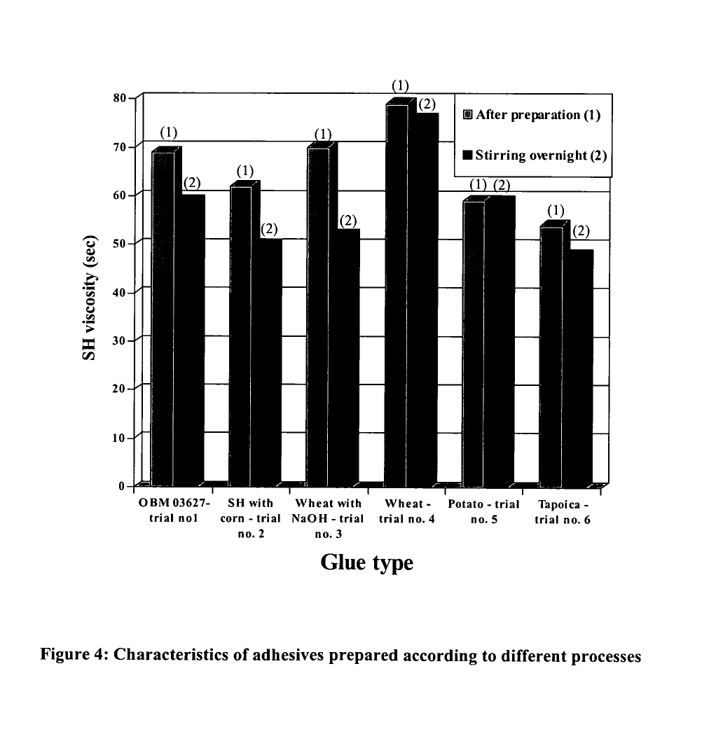

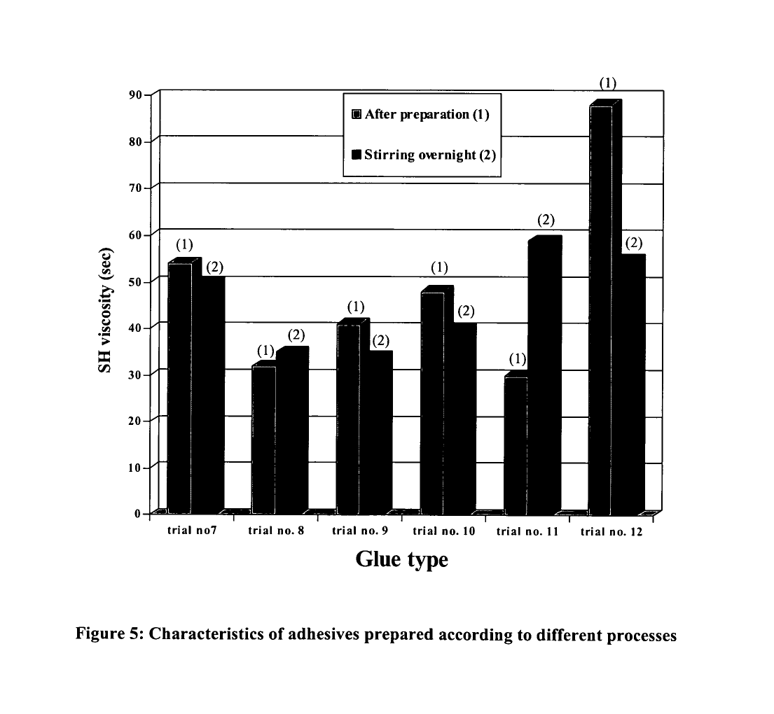

After the initial 30 minute preparation period, Stein Hall viscosity (SHV), Brookfield viscosity (BV) and gelatinisation temperature (GT) were measured. Both Stein Hall and Brookfield viscosity were measured at 30° C. Stein Hall viscosity was measured using a Stein Hall cup and according to standard methodology. Brookfield viscosity was also measured according to standard methodology, using spindle 3 at 100 rpm/min. Gelatinisation temperature of the adhesive was determined using Method 3 as described above. These measurements were then repeated after overnight stirring. The results are set out in Tables 3 and 4 and summarised in FIGS. 4 and 5.

TABLE 3

| | | 1 | 2 | 3 | 4 | 5 | 6 |
|---|---|---|---|---|---|---|---|
| After | SHV (sec) | 69 | 62 | 70 | 79 | 59 | 54 |
| prep. | BV (mPas) | 444 | 300 | 620 | 680 | 256 | 355 |
| | GT (° C.) | 53.6 | 57.3 | 56.5 | 56.3 | 55.6 | 56 |
| Stirring | SHV (sec) | 59 | 50 | 52 | 76 | 59 | 48 |
| overnight | BV (mPas) | 322 | 220 | 475 | 434 | 256 | 249 |
| | GT (° C.) | 55.5 | 58 | 58.5 | 57.2 | 57 | 56 |

TABLE 4

| | | 7 | 8 | 9 | 10 | 11 | 12 |
|---|---|---|---|---|---|---|---|
| After | SHV (sec) | 54 | 32 | 41 | 48 | 30 | 88 |
| prep. | BV (mPas) | 348 | 158 | 279 | 285 | 153 | 580 |
| | GT (° C.) | 50.9 | 49.8 | 50.1 | 49.5 | 51.8 | 48.8 |
| Stirring | SHV (sec) | 50 | 35 | 34 | 40 | 59 | 55 |
| overnight | BV (mPas) | 332 | 220 | 240 | 283 | 256 | 474 |
| | GT (° C.) | 53.8 | 53.2 | 52.9 | 53.0 | 54.1 | 53.4 |

From these results, it can be seen that glues prepared according to the present invention have properties that are at the very least comparable to traditional OBM or Stein Hall glues.

TABLE 1

| | Trial no. | | | | | | | | |
|---|---|---|---|---|---|---|---|---|---|
| | 1 | 2 | 3 | 4 | | 5 | | 6 | |
| Solid content | 25% = 350 g | 25% = 350 g | 25% = 350 g | 25% = 350 g | | 25.2% = 353.4 g | | 25% = 400 g | |
| Primary or Carrier | — | C*Gum 03431 | Native wheat | Native wheat starch | | Native potato starch | | Tapioca Starch | |
| starch | | | starch PT 20002 | PT 20002 | | 30082 | | Amilogill 500 | |
| % | — | 12 | 12 | 12 | | 10 | | 12 | |
| g | — | 40.44 | 40.44 | 38.76 | | 32.6 | | 44.4 | |
| C*Gum 03627^{a} | 350 g | — | — | — | | — | | — | |
| Secondary starch: | — | 296.54 g | 296.54 g | 284.25 g | | 293.8 g | | 325 g | |
| C*Gum 03431^{b} | | | | | | | | | |
| Alkali | — | NaOH solution | NaOH solution | Na₂CO₃ | Ca(OH)₂ | Na₂CO₃ | Ca(OH)₂ | Na₂CO₃ | Ca(OH)₂ |
| | | (33% solids) | (33% solids) | | | | | | |
| g | — | 24.55 | 24.55 | 13 | 9.1 | 13 | 9.1 | 14.8 | 10.4 |
| % d.s. based on | — | 0.58 | 0.58 | 3.71 | 2.6 | 3.69 | 2.6 | 3.70 | 2.6 |
| total OBM | | | | | | | | | |

| | | | | | | |
|---|---|---|---|---|---|---|
| Borax decahydrate | — | 4.9 | 4.9 | 4.9 | 4.9 | 5.4 |
| (g) | | | | | | |
| % d.s. based on | — | | 1.4 | 1.4 | 1.39 | 1.35 |
| total OBM | | | | | | |

^{a}C*Gum 03627 is an adhesive one-bag mix available from Cargill
^{b}C*Gum 03431 is a native corn starch available from Cargill

TABLE 2

| | Trial no. | | | | | | | | | | | |
|---|---|---|---|---|---|---|---|---|---|---|---|---|
| | 7 | | 8 | | 9 | | 10 | | 11 | | 12 | |
| Solid content | 20% = 280 g | | 25% = 350 g | | 25% = 350 g | | 30% = 420 g | | 30% = 420 g | | 30% = 420 g | |
| Primary or Carrier | Native potato | | Native potato | | Native potato | | Native potato | | Native potato | | Native potato | |
| starch | starch 30082 | | starch 30082 | | starch 30082 | | starch 30082 | | starch 30082 | | starch 30082 | |
| % | 19 | | 14 | | 15 | | 17 | | 12 | | 12 | |
| g | 55 | | 49 | | 52 | | 60 | | 50 | | 50 | |
| C*Gum 03627 | 350 g | | — | | — | | — | | — | | — | |
| Secondary starch: | 205 g | | 281 g | | 277 g | | 270 g | | 350 g | | 350 g | |
| C*Gum 20004^{c} | | | | | | | | | | | | |
| Alkali | Na₂CO₃ | Ca(OH)₂ | Na₂CO₃ | Ca(OH)₂ | Na₂CO₃ | Ca(OH)₂ | Na₂CO₃ | Ca(OH)₂ | Na₂CO₃ | Ca(OH)₂ | Na₂CO₃ | Ca(OH)₂ |
| g | 9 | 6 | 9.5 | 6.5 | 9.5 | 6.5 | 9 | 6.5 | 9.5 | 6.7 | 10.5 | 7.5 |
| % d.s. based on | 0.8 | 0.45 | 0.7 | 0.45 | 0.7 | 0.45 | 0.8 | 0.6 | 0.65 | 0.45 | 0.75 | 0.5 |
| total OBM | | | | | | | | | | | | |

| | | | | | | |
|---|---|---|---|---|---|---|
| Borax decahydrate | 2.8 | 3.5 | 3.5 | 3.5 | 4.2 | 4.2 |
| (g) | | | | | | |
| % d.s. based on | 1 | 1 | 1 | 1 | 1 | 1 |
| total OBM | | | | | | |

^{c}C*Gum 03431 is a native wheat starch available from Cargill

1-26. (canceled)

27. A dry adhesive composition comprising:
a carrier starch;
a secondary starch; and
an alkali;
wherein the carrier starch comprises, on a dry weight basis, less than about 50% pre-gelatinized starch, and wherein the carrier starch has a higher alkali sensitivity than the secondary starch.

28. The composition of claim 27 wherein the difference in alkali sensitivity between the carrier starch and the secondary starch is at least about 0.05% NaOH.

29. The composition of claim 27 wherein the difference in alkali sensitivity between the carrier starch and the secondary starch is at least about 0.15% NaOH.

30. The composition of claim 27 wherein the carrier starch comprises, on a dry weight basis, less than about 40% pre-gelatinized starch.

31. The composition of claim 27 wherein the carrier starch comprises, on a dry weight basis, less than about 5% pre-gelatinized starch.

32. The composition of claim 27 wherein the carrier starch does not comprise any pre-gelatinized starch.

33. The composition of claim 27 wherein the secondary starch is selected from the group consisting of corn starch, potato starch, wheat starch and mixtures of two or more thereof.

34. The composition of claim 27 wherein the carrier starch is selected from the group consisting of wheat starch, potato starch, tapioca starch, barley starch and mixtures of two or more thereof.

35. The composition of claim 27 wherein the carrier starch is a carboxy-methylated starch.

36. The composition of claim 27 wherein the composition comprises, on a dry weight basis, about 0.5% to about 60% carrier starch.

37. The composition of claim 27 wherein the composition comprises, on a dry weight basis, about 5% to about 15% carrier starch.

38. The composition of claim 27 wherein the composition comprises, on a dry weight basis, about 40% to about 99.5% secondary starch.

39. The composition of claim 27 wherein the composition comprises, on a dry weight basis, about 80% to about 90% secondary starch.

40. The composition of claim 27 wherein the alkali is selected from sodium carbonate, calcium hydroxide, sodium hydroxide or mixtures of two or more thereof.

41. The composition of claim 27 wherein the composition comprises, on a dry weight basis, about 1% to about 8% alkali.

42. The composition of claim 27 wherein the composition comprises, on a dry weight basis, about 3% to about 6% alkali.

43. The composition of claim 27 wherein the composition further comprises a boron compound.

44. The composition of claim 43 wherein the boron compound includes borax decahydrate.

45. The composition of claim 43 wherein the composition comprises, on a dry weight basis, about 0.1% to about 3.5% boron compound.

46. A process for preparing an adhesive comprising:
pre-mixing a dry adhesive composition comprising a carrier starch, a secondary starch and an alkali, the carrier starch comprising, on a dry weight basis, less than 50% pre-gelatinized starch and having a higher alkali sensitivity than the secondary starch, and wherein the amount of pre-mixed alkali is sufficient to gelatinize the carrier starch but not the secondary starch when mixed with a liquid;
adding the dry adhesive composition to water to form an aqueous adhesive composition; and
mixing the aqueous adhesive composition, thereby forming an adhesive with gelatinized carrier starch but not gelatinized secondary starch.

47. The process of claim 46 wherein the alkali is selected from sodium carbonate, calcium hydroxide, sodium hydroxide or mixtures of two or more thereof.

48. The process of claim 46 wherein following the pre-mixing step, the dry adhesive composition comprises, on a dry weight basis, about 1% to about 8% alkali.

49. The process of claim 46, further comprising adding a boron compound.

50. The process of claim 49 wherein the boron compound includes borax decahydrate.

51. The process of claim 49 wherein, on a dry weight basis, about 0.1% to about 3.5% boron compound is added.

52. The process of claim 49 wherein, on a dry weight basis, about 1.2% to about 1.7% boron compound is added.

53. The process of claim 46 wherein the water is pre-heated to about 20° C. to about 60° C.

54. The process of claim 46 wherein the water is pre-heated to about 35° C. to about 45° C.

55. The process of claim 46 wherein mixing the aqueous adhesive composition includes mixing the aqueous adhesive composition for about 10 minutes to about 1 hour.

56. An adhesive prepared according to the process of claim 46.

57. The adhesive of claim 56 wherein the adhesive is for use in at least one of corrugating and paper processing.

58. Board materials prepared using the adhesive of claim 56.
